(19) United States
(12) Patent Application Publication
(10) Pub. No.: US 2025/0079595 A1
(43) Pub. Date: Mar. 6, 2025

(54) BATTERY CELL ARRANGEMENT FOR A BATTERY OF A MOTOR VEHICLE WITH A THERMAL INSULATION TO INHIBIT HEAT TRANSMISSION BY HEAT RADIATION

(71) Applicant: Lisa Dräxlmaier GmbH, Vilsbiburg (DE)

(72) Inventors: Alexander HAHN, Röttenbach (DE); Michael STECKEL, Vilsbiburg (DE); Johannes KOLLMER, Geisenhausen (DE); Bernhard EDL, Bodenkirchen (DE); Alexander LACKNER, Geisenhausen (DE)

(73) Assignee: Lisa Dräxlmaier GmbH, Vilsbiburg (DE)

(21) Appl. No.: 18/949,583

(22) Filed: Nov. 15, 2024

Related U.S. Application Data
(63) Continuation of application No. PCT/EP2023/060822, filed on Apr. 25, 2023.

(30) Foreign Application Priority Data
May 16, 2022 (DE) 10 2022 112 233.6

(51) Int. Cl. H01M 50/213; H01M 10/0525; H01M 10/658; H01M 50/51; H01M 50/514

(52) U.S. Cl. CPC H01M 50/213; H01M 10/0525; H01M 10/658; H01M 50/51; H01M 50/514; H01M 2220/20

(57) ABSTRACT

A battery cell arrangement for a battery of a motor vehicle having a plurality of cylindrical battery cells, of which at least two battery cells are arranged as a pair of cells. One battery cell of the pair of cells is arranged in an axial direction behind the other battery cell of the cell pair such that a top region of the one battery cell faces a bottom region of the other battery cell. A contact element arranged between them produces an electrically conductive connection between the top region and the bottom region. A thermal insulation is arranged between the battery cells, and the insulation inhibits a heat transmission by heat radiation in the axial direction between the battery cells of the pair of cells.

### CROSS-REFERENCE TO RELATED APPLICATIONS

This application is a continuation of International Application No. PCT/EP2023/060822, filed on Apr. 25, 2023, which claims priority to and the benefit of DE 10 2022 112 233.6, filed on May 16, 2022. The disclosures of the above applications are incorporated herein by reference.

### FIELD

The present disclosure relates to a battery cell arrangement for a battery of a motor vehicle.

### BACKGROUND

The statements in this section merely provide background information related to the present disclosure and may not constitute prior art.

If a thermal runaway occurs in a single lithium cell of a battery pack, there should be guards in place to inhibit the heat from spreading to adjacent cells, causing a so-called thermal propagation. Current standards therefore include trials to verify the safety of the battery with respect to thermal propagation.

With cylindrical battery cells, there is normally electrical contact between the cells via the end faces of the battery cells, which face one another respectively, that is to say, by means of an electrically conductive connection between a top area of a cell and a bottom area of the adjacent cell facing it (in axial direction). A transmission of heat from one battery cell to the adjacent cell occurs in axial direction, also via these end faces.

Heat transmission is normally based on both thermal conduction and thermal radiation. Due to the end-face electrical contact in cylindrical battery cells of this kind, it can be difficult to realize a reduction in the thermal transmission, in particular transmission that is due to heat radiation.

### SUMMARY

This section provides a general summary of the disclosure and is not a comprehensive disclosure of its full scope or all of its features.

The present disclosure aims to reduce, as far as possible, heat transmission by heat radiation in an axial direction between two cylindrical battery cells.

The battery cell arrangement for a battery of a motor vehicle has a plurality of cylindrical battery cells. The battery arrangement can, for example, include a traction battery of an electrically driven motor vehicle. At least two of the cylindrical battery cells are arranged as a pair of cells, wherein one battery cell of the pair of cells is arranged behind the other battery cell of the pair of cells such that a top area of one battery cell faces the bottom region of the other battery cell. In axial direction, the cylindrical battery cells can be longer than their diameter.

A contact element is arranged in axial direction between the top region of one battery cell and the bottom region of the other battery call, producing an electrically conductive connection with the bottom region. In other words, the battery cells of the pair of cells have an electrically conductive connection with each other in the form of a serial connection. A negative pole of one battery cell thus has an electrically conductive connection with the other battery cell of the battery pair.

A thermal insulation is arranged in axial direction between the battery cells of the battery pair and inhibits heat transmission by thermal radiation in axial direction between the battery cells of the pair of cells. The thermal insulation also provides that the least possible heat transmission by thermal radiation can occur in axial direction between the two adjacent battery cells of the battery pair. The present disclosure is also based on the recognition that at high temperatures in particular, thermal radiation is a major factor in heat transmission. Thus, in the event of a thermal runaway, the first few minutes, for example the first five minutes, play a particularly major role in the transfer of heat resulting from heat radiation to the adjacent cell in the pair of cells.

With cylindrical battery cells, the positive and negative connections are arranged on each end face respectively, in the top region or the bottom region. In a pair of cells, there are no additional battery cells between the two battery cells. The battery cells in the pair of cells are thus immediately adjacent to each other in axial direction. The respective axes of the battery cells that form the pair of cells, are arranged flush, particularly in axial direction, one behind the other in axial direction. The thermal insulation arranged in axial direction between the battery cells is a kind of thermal shield or a kind of thermal reflector against thermal radiation.

Heat radiated by one battery cell, for example by its top region, is reflected back by the thermal insulation in the direction of the top region, so that no heat, or only very little heat is transmitted by heat radiation in axial direction from the top region to the bottom region of the adjacent battery cell. This also applies in reverse. Heat radiated in axial direction from the bottom region to the top region is reflected back in the direction of the bottom region by the thermal insulation. This also means that only very little heat radiation can be transmitted by thermal radiation from the bottom region in the direction of the top region.

In addition, with the battery cell arrangement of the present disclosure, heat transmission by thermal radiation in axial direction between two cylindrical battery cells is also reduced as far as possible. This also contributes toward safe operation of the battery cell arrangement.

One possible example of the present disclosure provides for the thermal insulation to have a reflectance of at least 0.5 in a wavelength range of 1000 to 10,000 nanometers. In this respect, the present disclosure is based on the recognition that a substantial part of the heat transmission takes place at a wavelength between 1000 and 10,000 nanometers. Since the thermal insulation has a reflectance of at least 0.5 in the aforementioned wavelength region, the heat transmission by thermal radiation in axial direction between the adjacent battery cells of the battery pair can be substantially reduced.

An additional possible example of the present disclosure provides for the battery cells to be lithium cells. The battery cells can thus be lithium-ion cells, for example battery cells based on lithium-nickel-cobalt-aluminum oxides, lithium-nickel-manganese-cobalt oxides, or also, for example, on lithium iron phosphates. Lithium cells have the following advantages among others: good charging efficiency, a high number of charging cycles, good high-current capability, good energy density, and relatively large discharge depths which can be withstood without damage.

A further possible example of the present disclosure provides for the thermal insulation, seen in axial direction, to completely cover the battery cells of the pair of cells. This can, for example, mean that the thermal insulation has the same diameter as the battery cells of the pair of cells. Emanating in axial direction, the thermal insulation extends at least as far in the radial direction as the battery cells, and as a result, each of the battery cells of the pair of cells is particularly effectively shielded by the thermal insulation against heat radiation from the other.

An additional possible example of the present disclosure provides for the thermal insulation to be a plate or a film or foil which is arranged on the top region and/or on the bottom region. The plate or the foil can, for example, be glued or fixed in some other way to the top region or also to the bottom region. A plate or a foil of this kind can be particularly easily manufactured and arranged on the top region or on the bottom region.

A further possible example of the present disclosure provides for the thermal insulation to be a coating on the bottom region and/or on the contact element. The coating can, for example, also be an application of varnish. Other kinds of coatings are also possible. Both the bottom area and the contact element can be relatively easily provided with a coating of this kind, in order to provide an inexpensive and effective thermal insulation against heat transmission by thermal radiation.

An additional possible example of the present disclosure provides for the thermal insulation to be manufactured, at least in part, from a metal oxide. Metal oxides do in some cases have very good properties with regard to the reflection of thermal radiation. The thermal insulation can, for example, be manufactured at least partially from titanium dioxide, zinc oxide, or stannic oxide.

Another possible example of the present disclosure provides for the contact element to be arranged frontally and flatly on a part of the top region which is raised in axial direction, said contact element laterally encompassing the bottom region; part of the thermal insulation is arranged in axial direction between the contact element and the bottom region and completely covers the bottom region; another part of the thermal insulation is arranged on the side of the contact element that faces away from the bottom region and annularly encompasses the raised part of the top region. The bottom region of the battery cell is also completely covered by the thermal insulation and in that way very effectively shields the bottom region against heat transmission by thermal radiation. In addition, the top region, due to the thermal insulation placed on the side of the contact element that faces away from bottom region, is also very well protected against heat transmission by thermal radiation.

Another possible example of the present disclosure provides for the battery cell arrangement to have a plurality of such pairs of cells. The battery cells for each pair of cells, which are arranged adjacently and serially in axial direction, are also very well protected against heat transmission by thermal radiation. That can reduce the risk of a thermal runaway of the entire battery cell arrangement. Provision can also be made for each battery cell of the battery cell arrangement to be part of one of the cell pairs. In that way, all of the battery cells that are arranged adjacent to each other in axial direction are protected against reciprocal heat transmission by this kind of thermal insulation.

Additional advantages, characteristics, and details of the present disclosure can be seen in the following description of possible examples and in the drawings. The characteristics and combinations of characteristics shown in the description above, as well as the characteristics and combinations of characteristics shown below in the description of the figures, and/or in the figures alone, are applicable not only to the respectively described combinations, but also to other combinations or in isolation, without departing from the scope of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a battery cell arrangement having a plurality of cylindrical battery cells, wherein some of the battery cells are in each instance arranged serially in pairs in axial direction according to the present disclosure;

FIG. 2 is a schematic side view of a pair of cells of the plurality of battery cells arranged serially in axial direction, between which a thermal insulation is provided to reduce the heat transmission by thermal radiation according to the present disclosure; and

FIG. 3 is a schematic side view of a pair of cells, wherein a second example of the thermal insulation is shown according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

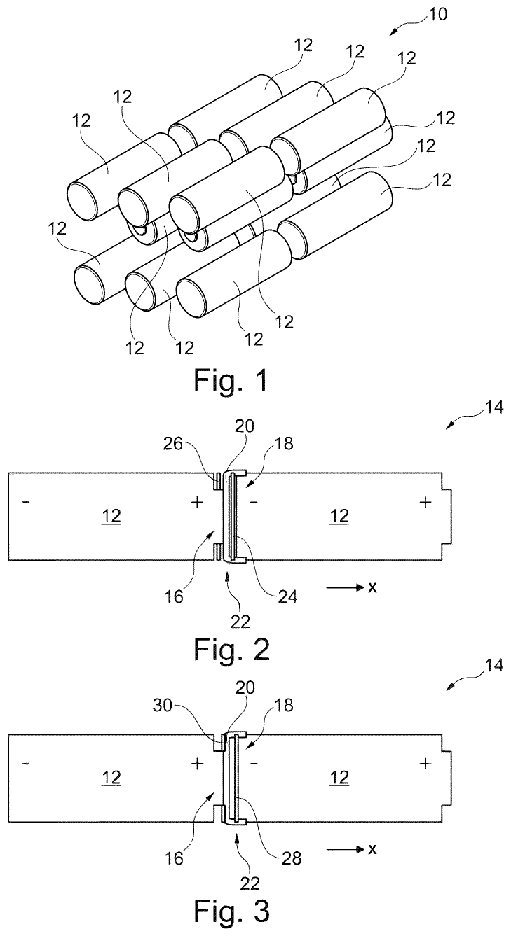

A battery arrangement 10 for a motor vehicle is shown in a perspective view in FIG. 1. The battery cell arrangement 10 has a plurality of battery cells 12, these battery cells 12 being cylindrical cells. The battery cells 12 can be lithium cells.

FIG. 2 shows a pair of cells 14 in a schematic side view, which depicts two of the battery cells 12. One battery cell 12 of the pair of cells 14 is arranged behind the other battery cell 12 in the pair of cells 14 in axial direction x such that a top region 16 of one of the battery cells 12 faces a bottom region 18 of the other battery cell 12. In the instance shown here, the top region 16 has a plus pole of one battery cell 12, the bottom region 16 having a negative pole of the other battery cell 12.

A contact element 20 producing an electrically conductive connection between the bottom region 18 and the top region 16 is arranged between the bottom region 18 and in the top region 16. In addition, a thermal insulation 22 is arranged between the battery cells 12, the thermal insulation 22 inhibiting a heat transmission by thermal radiation in the axial direction x between the battery cells 12 of the pair of cells 14.

The example of the thermal insulation 22 shown here includes two plates 24, 26. The plates 24, 26 can also be made of foil, for example. One plate 24 is arranged in the proximity of the bottom region 18 or the right battery cell 12, specifically between the bottom region 18 and the contact element 20. The other plate 26 is arranged in the top region 16 of the left battery cell 12. Seen in axial direction x, the thermal insulation 22 covers the respective battery cells 12.

The thermal insulation 22, in this instance the plates 24, 26, can also, for example, be made of a metal oxide, such as, for example, titanium oxide, zinc oxide, stannic oxide or the like. The thermal insulation 22 can have a reflectance of at least 0.5 in a wavelength region of 1000 to 10,000 nanometers.

If the left cell of battery cells 12 shown here develops a great deal of heat, due for example to a cell thermal event, the thermal insulation 22 provides that the heat transmission by thermal radiation in axial direction x from the left battery cell 12 to the right battery cell 12 is inhibited, and vice versa.

FIG. 3, in turn, shows a pair of battery cells 14 wherein, in this example, the insulation layer 22 differs from the example shown in FIG. 2. In the case illustrated here, the thermal insulation 22 is formed by a coating 28 on the bottom region 18, and by an additional coating 30 on the contact element 20.

In other words, a cell bottom of the right battery cell 12 is provided with the coating 28. The other coating 30 is applied to the side of the contact element 20 that faces away from the bottom of the cell, or as the case may be, away from the bottom region 18, not including, however, a raised part of the top region 16 that is not described in detail here.

As can be discerned from FIG. 1, the battery cell arrangement 10 has a plurality of pairs of cells 14 of this kind, wherein, in each instance, thermal insulation 22 of this kind is arranged in the axial direction x between the respectively adjacent battery cells 12, the thermal insulation inhibiting a heat transfer by thermal radiation in the axial direction x between the respective battery cells 12 of the respective pairs of cells 14. In addition, more than two battery cells 12 can be arranged serially in the axial direction x. Each two battery cells adjacent to each other in the axial direction x then form a cell pair 14 of this kind, where between the adjacent battery cells 12, that is between the respective top region 16 and bottom region 18, a thermal insulation 22 of this kind is provided to inhibit heat transfer by thermal radiation.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery cell arrangement for a battery of a motor vehicle comprising:
a plurality of cylindrical battery cells of which at least two battery cells are arranged as a cell pair with a first battery cell of the cell pair arranged in an axial direction behind a second battery cell of the cell pair so that a top region of the first battery cell faces a bottom region of the second battery cell, and a contact element is arranged between the first battery cell and the second battery cell to produce an electrically conductive connection with the bottom region; and
a thermal insulation is arranged in the axial direction between the at least two battery cells, the thermal insulation is configured to inhibit a heat transmission by thermal radiation in the axial direction between the at least two battery cells of the cell pair.

2. The battery cell arrangement according to claim 1, wherein the thermal insulation has a reflectance of at least 1.5 in a wavelength range of 1000 to 10,000 nanometers.

3. The battery cell arrangement according to claim 1, wherein the plurality of cylindrical battery cells are lithium cells.

4. The battery cell arrangement according to claim 1, wherein the thermal insulation completely covers the at least two battery cells of the cell pair in the axial direction.

5. The battery cell arrangement according to claim 1, wherein the thermal insulation is a plate or a foil, which is arranged on at least one of the top region and the bottom region.

6. The battery cell arrangement according to claim 1, wherein the thermal insulation is a coating on at least one of the bottom region and the contact element.

7. The battery cell arrangement according to claim 1, wherein the thermal insulation is manufactured at least in part from a metal oxide.

8. The battery cell arrangement according to claim 1, wherein the contact element is arranged frontally and flatly on a raised part of the top region and laterally encompasses the bottom region, a part of the thermal insulation is arranged in the axial direction between the contact element and the bottom region and completely covers the bottom region, and another part of the thermal insulation is arranged on a side of the contact element that faces away from the bottom region and annularly encompasses the raised part of the top region.

9. The battery cell arrangement according to claim 1, wherein the battery cell arrangement further comprises a plurality of the cell pairs.

10. The battery cell arrangement according to claim 9, wherein each battery cell of the plurality of cylindrical battery cells is part of one of the plurality of the cell pairs.
